(19) United States
(12) Patent Application Publication
(10) Pub. No.: US 2021/0004738 A1
(43) Pub. Date: Jan. 7, 2021

(54) USE OF SERVICE PATTERN IDENTIFIER IN AUGMENTATION OF SERVICE CATALOG

(71) Applicant: International Business Machines Corporation, Armonk, NY (US)

(72) Inventors: Clea Anne Zolotow, Key West, FL (US); Alexander Schmid, Harburg (DE); Pedro Soares, Silveira (PT); Pritpal S. Arora, Bangalore (IN)

(21) Appl. No.: 16/503,818

(22) Filed: Jul. 5, 2019

(51) Int. Cl. G06Q 10/06; G06N 20/00; G06Q 10/04

(52) U.S. Cl. CPC G06Q 10/0633; G06Q 10/04; G06N 20/00; G06Q 10/0631

(57) ABSTRACT

A service catalog system where patterns in a service catalog (respectively corresponding to various available services) are modified based on consumption data (that is, how other users have used the services in the past). Also, a service catalog system where a pattern is added to a service catalog based on consumption data. Some embodiments use artificial intelligence (AI), machine learning (ML), cognitive processing and/or advanced analytics to modify existing patterns and/or recommend new patterns to be added to the service catalog.

### BACKGROUND

The present invention relates generally to the field of service catalogs. As the term is used herein, a “service catalog” is an organized and curated collection of any and all business and information technology related services that can be performed by, for, or within an enterprise. Service catalogs typically act as knowledge management tools for the employees and consultants of an enterprise, allowing them to route their requests for and about services and services related topics to the subject matter experts. The subject matter experts typically own, are accountable for, and operate respective services. Each service within such service catalogs is usually very repeatable and has controlled inputs, processes, and outputs. The catalogs are typically implemented in a manner that facilitate the registration, discovery, request, execution, and tracking of desired services for catalog users. Each service within the catalog typically includes one, or more, of the following traits and elements: (i) clear ownership of and accountability for the service (a person and often an organization); (ii) a name or identification label for the service; (iii) a description of the service; (iv) a service categorization or type that allows it to be grouped with other similar services; (v) related service request types; (vi) any supporting or underpinning services; (vii) service level agreement (SLA) data and information that helps service providers set expectations for their service requestors; (viii) who is entitled to request/view the service; (ix) associated costs (if any); (x) how to request the service and how its delivery is fulfilled; and/or (xi) escalation points and key contacts. To further explain item (x) on the foregoing list, when a service pattern is requested, it usually comes with approval information (for example, a 0.5 VM with 5 Gb of RAM may not need approval, or may need only a low level of approval, but a 10 VM with 3 Tb of Ram may need approval from finance and the cost code owner). In other words, item (x) may include approval for a new pattern, and/or approvals for specific instances of resource use (such as an instantiation of a VM).

The concept of “services” is known. A service is the designation for what can be consumed from the catalog. Depending on the context it can be composed of many different elements (application, middleware, hardware/infrastructure, corresponding services to implement and/or run, standard typologies, etc.), but fundamentally services are what is available for catalog users to “buy” or to consume.

The concept of “artificial intelligence” is known. For purposes of this document, artificial intelligence is defined as advanced analysis and logic-based techniques to interpret events, support and automate decisions, and take actions. AI based techniques are based on advanced forms of a statistical and mathematical model. AI based techniques make it possible for a computer or machine to compute tasks that are supposed to be done by humans.

The concept of “patterns” is known. A pattern is a set of parameter value(s) and or parameter value ranges that define things that fit within the pattern and exclude things that are outside of the pattern. Here is an example of a pattern for states of the United States: any state of the United States that: (i) has between 10M and 20M in population; (ii) has at least one city with over 2M in its population; and (iii) has at least two words in its state name. North Carolina would not meet this pattern because it has no city over 2M in population. As of this writing New York is the only state that would meet this pattern.

US patent application 20170193021 (“Deng”) states as follows: “[A]nalytics is performed on the knowledge base to identify at least one common pattern of deployment, configuration, or other attribute vector types, or a combination thereof. The analytics may be performed using a variety of techniques including database query technique, machine learning techniques, and clustering techniques. The common set of patterns may be used to identify what deployments, configurations, and/or other attribute vectors the application instances will be in after they are migrated from an enterprise environment to a hosted environment. These may be applied to a service catalog . . . . In another example, the common set of patterns are applied to one of cloud service catalog, cloud machine images, cloud workflows, and cloud design implementations.” (reference numerals omitted)

### SUMMARY

According to an aspect of the present invention, there is a method, computer program product and/or system that performs the following operations (not necessarily in the following order): (a) receiving an initial version of a service catalog including information indicative of: (i) a plurality of information technology services, (ii) a plurality of pattern definitions used to match user requests to information technology services of the plurality of technology information services; (b) receiving a consumption data set including information indicative of use of the plurality of information technology services and the initial version of the service catalog by a plurality of users; (c) applying artificial intelligence to modify an initial version of a first pattern definition of the plurality of pattern definitions based, at least in part, on the consumption data set to obtain a modified version of the first pattern definition; and (d) replacing the initial version of the first pattern definition with the modified version of the first pattern definition in the service catalog to obtain a modified version of the service catalog.

According to a further aspect of the present invention, there is a method, computer program product and/or system that performs the following operations (not necessarily in the following order): (a) receiving an initial version of a service catalog including information indicative of: (i) a plurality of information technology services, (ii) a plurality of pattern definitions used to match user requests to information technology services of the plurality of technology information services; (b) receiving a consumption data set including information indicative of use of the plurality of information technology services and the initial version of the service catalog by a plurality of users; (c) applying artificial intelligence to recommend a new pattern definition and corresponding new information technology service based, at least in part, on the consumption data set; (d) obtaining approval to add the new pattern definition and corresponding new information technology service to the service catalog; and (e) responsive to the approval to add the new pattern definition and corresponding new information technology service to the service catalog, adding the new pattern definition and corresponding new information technology service to the original version of the service catalog to obtain a modified version of the service catalog.

According to a further aspect of the present invention, there is a method, computer program product and/or system that performs the following operations (not necessarily in the following order): (a) receiving a first version of a service catalog including information indicative of: (i) a plurality of information technology services, (ii) a plurality of pattern definitions used to match user requests to information technology services of the plurality of technology information services, with each pattern definition including a plurality of parameter value ranges respectively corresponding to a plurality of relevant parameters; (b) receiving a consumption data set including information indicative of use of the plurality of information technology services and the first version of the service catalog by a plurality of users; (c) automatically modifying a first version of a first pattern definition of the plurality of pattern definitions based, at least in part, on the consumption data set to obtain a second version of the first pattern definition, with the modification of the first pattern definition including a change to a first parameter value range included in the first pattern definition; and (d) replacing the first version of the first pattern definition with the second version of the first pattern definition in the service catalog to obtain a second version of the service catalog.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a block diagram view of a second embodiment of a system according to the present invention;

FIG. 6 is a block diagram view of a portion of the second embodiment system, showing multiple clients;

FIG. 7 is a flowchart showing a second embodiment method performed, at least in part, by the second embodiment system; and

FIG. 8 is a flowchart showing a third embodiment method performed, at least in part, by the second embodiment system.

### DETAILED DESCRIPTION

Some embodiments of the present invention are directed to a system where patterns in a service catalog (respectively corresponding to various available services) are modified based on consumption data (that is, how other users have used the services in the past). Some embodiments of the present invention are directed to a system where a pattern is added to a service catalog based on consumption data. Some embodiments use artificial intelligence (AI), machine learning (ML), cognitive processing and/or advanced analytics to modify existing patterns and/or recommend new patterns to be added to the service catalog. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

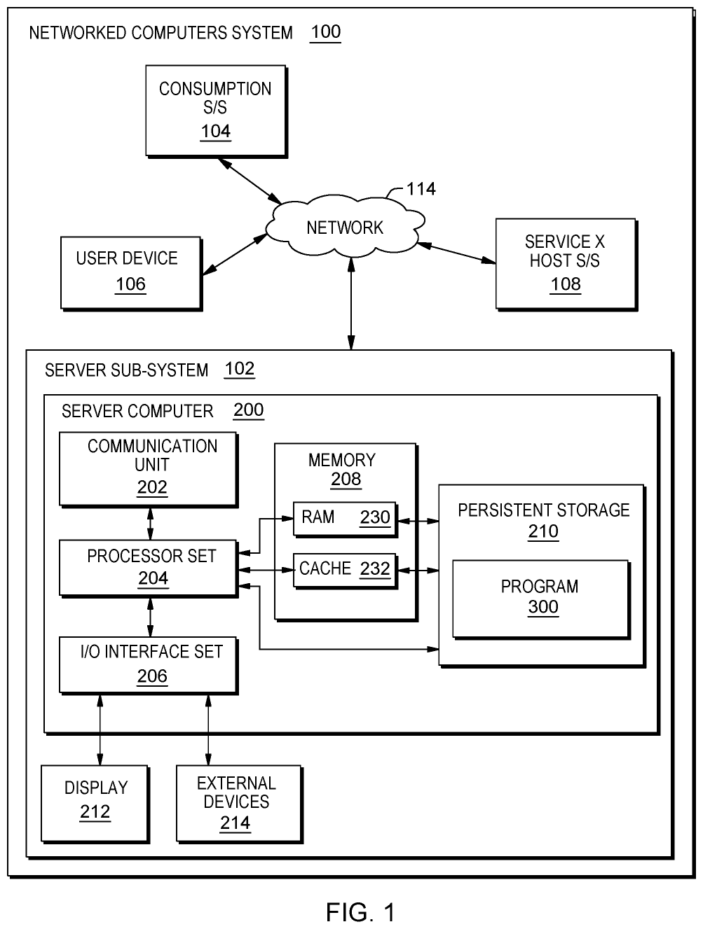

An embodiment of a possible hardware and software environment for software and/or methods according to the present invention will now be described in detail with reference to the Figures. FIG. 1 is a functional block diagram illustrating various portions of networked computers system 100, including: server subsystem 102; consumption subsystem 104; user device 106; service X host subsystem 108; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Subsystem 102 is, in many respects, representative of the various computer subsystem(s) in the present invention. Accordingly, several portions of subsystem 102 will now be discussed in the following paragraphs.

Subsystem 102 may be a laptop computer, tablet computer, netbook computer, personal computer (PC), a desktop computer, a personal digital assistant (PDA), a smart phone, or any programmable electronic device capable of communicating with the client subsystems via network 114. Program 300 is a collection of machine readable instructions and/or data that is used to create, manage and control certain software functions that will be discussed in detail, below, in the Example Embodiment sub-section of this Detailed Description section.

Subsystem 102 is capable of communicating with other computer subsystems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

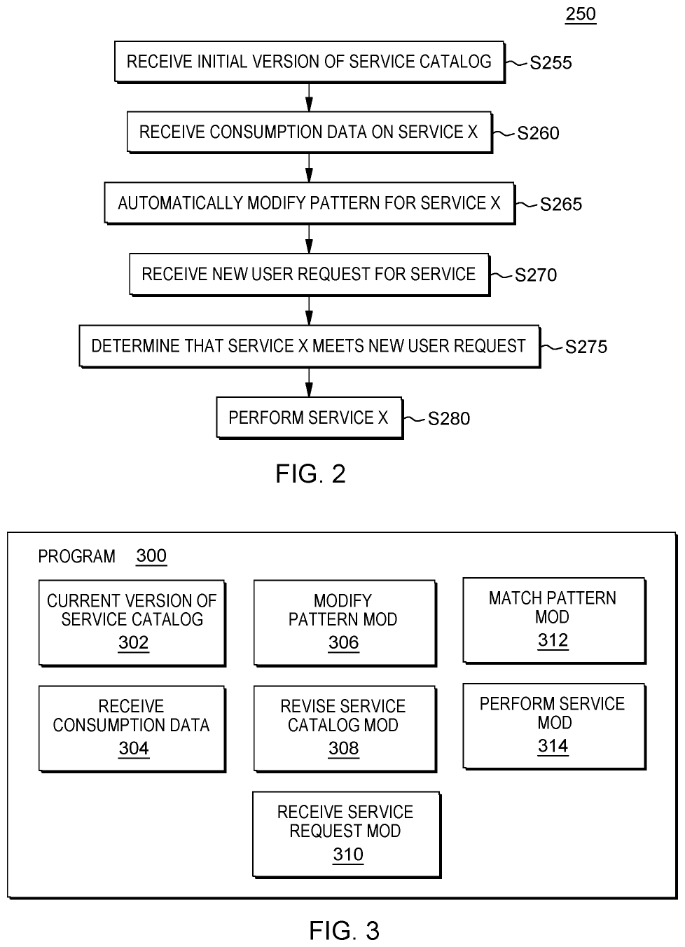

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where the current version of a service catalog 302 is received by program 300. In this example, the service catalog is a new catalog when it is received. Alternatively, a current version of the service catalog 302 can be received by being developed within program 300 of server subsystem 102 (see FIG. 1).

The service catalog includes the identity of all of the available services. In this example, the services are Service A to Service Z (not separately shown in the Figures). In this example, each service has a corresponding pattern definition (sometimes more simply referred to as a pattern). Generally speaking, a pattern definition for a service is a set of parameter value ranges that define where it is appropriate to use the corresponding service. In this example, each service has one pattern. Alternatively, a service may correspond to more than one pattern definition. It is further noted that a parameter value range in a pattern may be as small as a single value. In this example, each pattern has value ranges for the following parameters: operating system, VM size, management characteristics, environment type and application type. Alternatively, other parameters related to a provision of information technology services (now known or to be developed in the future) may be used.

In this example, one of the services is Service X, which is described as Medium size virtual machine with Linux, fully Managed, Production, Application type A. Service has the following control inputs (also called associated parameters): (i) operating system(s); (ii) VM size, (iii) management characteristics; (iv) environment type(s) and (v) application type(s). Alternatively, other services may use different parameters in their corresponding pattern definitions. For example, parameters included in pattern definitions may include one, or more, of the following: backup configuration, geo-location related (for example, geo-location restrictions based on GDPR (general data privacy regulations) requirements), staffing (for example, on-shore, near-shore, off-shore, language requirements), storage I/O requirements, virtual network interface controller capabilities, similar amounts of RAM and CPU (or same ratio on a substantial number of requests), cloud provider, network attachment configuration, basic security configuration, and/or cluster type related.

In this example, the corresponding pattern definition for Service X includes the following parameter value ranges: (i) operating system must be Linux; (ii) VM size 40 to 60 VM size units (this is initially considered to be a medium size); (iii) management characteristics must be fully managed or “micro-managed” (this is, managed even more rigorously than a fully managed VM); (iv) environment type(s) must be environment type A, environment type B or environment type F; and (v) application type must be application type A. This pattern definition is included in the initial version of the service catalog to help determine whether Service X can be used to fulfill various user requests. This example will focus on the parameter of VM size as it relates to the pattern definition corresponding to Service X.

Processing proceeds to operation S260, where receive consumption data 304 receives consumption data relating to Service X from consumption subsystem 104 through communication network 114 (see FIG. 1). In this example, the consumption data on Service Z includes the following: (i) Service X was invoked as an exception (rather than by pattern matching) 100 times in the past; (ii) in each of these exception invocations, all of the parameter values of the user's request were within the pattern definition except for VM size; (iii) for 50 of the exception type invocations of Service X, the requested VM size was between 61 and 65 (inclusive); (iv) for the 50 exception type invocations of Service X where requested VM size was between 61 and 65, the results were satisfactory 98% of the time; (v) for 50 of the exception type invocations of Service X, the requested VM size was between 66 and 70 (inclusive); and (vi) for the 50 exception type invocations of Service X where requested VM size was between 66 and 70, the results were satisfactory 22% of the time.

Other examples of consumption data will be discussed, below, in the following subsection of this Detailed Description section.

Processing proceeds to operation S265, where: (i) modify pattern module (“mod”) 306 modifies the pattern corresponding to Service X based on the consumption data received at operation S260; and (ii) revise service catalog mod 308 revises the current version of the service catalog 302 to replace the old version of the pattern for Service X with the new version of the pattern for Service X.

More specifically, the machine logic of modify pattern mod 306 recognizes that Service X will usually work when the VM size is as large as 65 VM size units, but also that Service X will not usually work when the VM size is above 65 VM size units. Accordingly, mod 306 changes the parameter value range for VM size for Service X from 40-60 to 40-65. By making the parameter value range more expansive in this regard, fewer new service requests will be likely to require an exception, and the extra time and resources associated with an exception. Mod 308 incorporates this pattern change automatically into current version of service catalog 302.

Processing proceeds to operation S270, where receive service request mod 310 receives a new user request for service from the user device 106 through communication network 114 (see FIG. 1). The parameter values of this new service request are as follows: (i) operating system=Linux; (ii) VM size=62 VM size units; (iii) management characteristics=micro-managed; (iv) environment type B; and (v) application type=application type A.

Processing proceeds to operation S275, where match pattern mod 312 determines that the revised pattern corresponding to Service X in current version of service catalog 302 matches the new service request. Therefore, Service X can be used to fulfill the new service request and is likely to work.

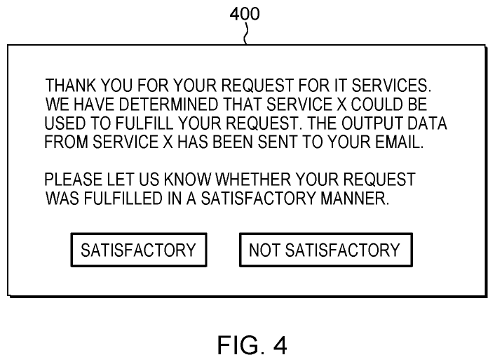

Processing proceeds to operation S280, where perform service mod 314 directs service X host subsystem 108 to perform Service X in response to the new service request. As can be seen from screenshot 400 of FIG. 4, in this example, the user is given an opportunity to communicate whether Service X was satisfactory with respect to the user's needs.

### III. Further Comments and/or Embodiments

Some embodiments of the present invention recognize the following facts, potential problems and/or potential areas for improvement with respect to the current state of the art: (i) is common to have deviations between established business objectives and the enterprise it (information technology) service catalog; (ii) this is often caused by the gaps between business and it; (iii) one reason is the lack of a structured process to derive the it service catalog from the business objectives; (iv) but the main reason is that there is no structured and dynamic process to keep it updated and consistent; (v) the service catalog represents a strategic element to implement the it strategy; (vi) it allows the IT organization to channel the user requests into pre-configured services which are aligned to the overall IT strategy; (vii) the service catalog represents a strategic element to implement the it strategy; (viii) it is a genuine representation of the business needs; (ix) it allows the it organization to channel the user requests into pre-configured services which are aligned to the overall IT strategy; (x) building and maintaining the catalog is not a trivial task that typically consumes a lot of resources; and/or (xi) in most cases it is completely manual and therefore it is prone to errors and deviations.

If the catalog does not reflect the requirements of the business, there can be severe impact on business and on the IT side: (i) the business cannot perform efficiently because the necessary it services are not provided as needed or not in the required timeframe; (ii) on the IT side the number of exception requests increase; (iii) the handling of exception requests requires additional effort compared to the handling of services which are part of the catalog; (iv) on top of that there may be significant additional effort required to fulfill the request, build the service and to provide the service on an ongoing basis; (v) in most cases exception requests cannot be channeled into standard services which are part of the catalog; and/or (vi) therefore, the resulting benefits for the it organization cannot be leveraged (for example, increase standardization and efficiency within it).

Some embodiments of the present invention may include one, or more, of the following features, characteristics, components, operations and/or advantages: (i) a cognitive service pattern identifier which allows the dynamic augmentation of a service catalog; (ii) an engine with machine learning capabilities that registers all changes and requests to the catalog and use that to make recommendations and even small automated adjustments, sometimes herein referred to as the dynamic catalog update component (DCUC); (iii) a component that looks for patterns of usage to build additional insights on similar requests or new-found patterns, sometimes herein referred to as the pattern identifier (PI); and/or (iv) cognitive concepts with feedback loops to ensure continuous learning and optimization.

Some embodiments of the present invention may include one, or more, of the following features, characteristics, components, operations and/or advantages: (i) on the dynamic catalog update component (DCUC) that includes a pattern identifier (PI); (ii) the DCUC/PI include a unique method to identify similarity matching patterns on the consumer/enterprise requests to add, update or remove services in a service catalog; (iii) templates for service catalog generation and maintenance; (iv) adds the data collection, analytics and ai rules to feedback automated adjustments and human readable suggestions; (v) this can significantly contribute to a self-maintained catalog; (vi) this catalog will reflect the requirements of the business; (vii) at the same time, this catalog will help to increase efficiency within it, as the catalog allows the IT organization to channel the user requests into pre-configured services which are aligned to the overall IT strategy; (viii) catalog can be a fundamental piece in a multi-service, multi-provider strategy; (ix) provides a catalog of services for hybrid clouds and ITaaS (IT as a service) topologies with relatively low maintenance costs; (x) provides a catalog of services for hybrid clouds and ITaaS (IT as a service) topologies with little or no gaps between user needs, business directives and catalog operations and orchestration; and/or (xi) an AI based optimizer (like the DCUC in some embodiments of the present invention) would reduce most issues, and increase effectiveness, directly cutting cost and potentially increasing service consumption and revenue by providing the most apt items in the catalog.

A method, according to an embodiment of the present invention, performs the following operations: (i) a workflow based mechanism performs an ongoing, dynamic analysis of the existing user requests, reflecting the business needs of the enterprise; (ii) based on these requests, cognitive technology is used to derive suggestions for a corresponding update of the catalog; and (iii) based upon these suggestions the service catalog is continuously aligned to the requirements of the users and therefore to align the service catalog to the business needs of the enterprise.

The essence of the invention are two new components, the Dynamic Catalog Update Component (DCUC) and the Pattern Identifier (PI), which can be configured to work on any catalog structure.

The IT service catalog overview of the IT service catalog is the representation of the IT services which are provided to its users. These users can be located in all Business Units of the organization including the IT itself. The users can even be located outside the organization. Each service in the IT service catalog is described by a set of parameters. This set of parameters may include the description of the service, available options, available tiers (for example Gold, Silver, Bronze), corresponding SLAs (service level agreements), corresponding prices, etc. Requests for services which are not included in the catalog are covered through a special process requiring specific approvals. This is an exception process, the use of which should be minimized, because it requires additional efforts during the processing of the request (one-of-a-kind) and it especially requires additional efforts to fulfill the request and to build and to provide the service on an ongoing basis.

Objectives and Benefits of the IT service catalog will now be discussed. The IT service catalog is a potentially critical element. On the one hand, the service catalog eases the interaction between the user and the IT. It ensures a fast and smooth ordering of pre-defined IT services with pre-defined costs. At the same time, the catalog should include those services which are really needed by the users. On the other hand, the service catalog is a potentially important lever to implement its IT strategy. The service catalog represents the strategic IT services and it allows the IT organization to channel the user requests into pre-configured services which are aligned to the overall IT strategy. This allows the IT organization to increase standardization and can cause an increase in efficiency within IT.

Monitoring and analysis of service usage will now be discussed. As part of some embodiments of the present invention, the usage of services which are provided to the users are monitored, stored and analyzed. This includes the services which are part of the catalog, but also the services which are not part of the catalog. It covers a list of relevant parameters which may include (but are not limited to): the actual service, options, tiers, duration the service is used, etc. These parameters are used by the Dynamic Catalog Update Component (DCUC) and Pattern Identifier (PI) to analyze, whether the contents of the catalog still reflect the actual needs of the users. Based on this analysis, the DCUC develops recommendations to update the catalog. Depending on the specific implementation, this recommendation could be forwarded to the owner of the service catalog for a cross-check with the overall IT strategy and a corresponding approval. Afterwards the recommendations are integrated in the next version of the service catalog. The decision of the approver to approve or dis-approve flows back to the DCUC/PI for a corresponding optimization of the DCUC/PI.

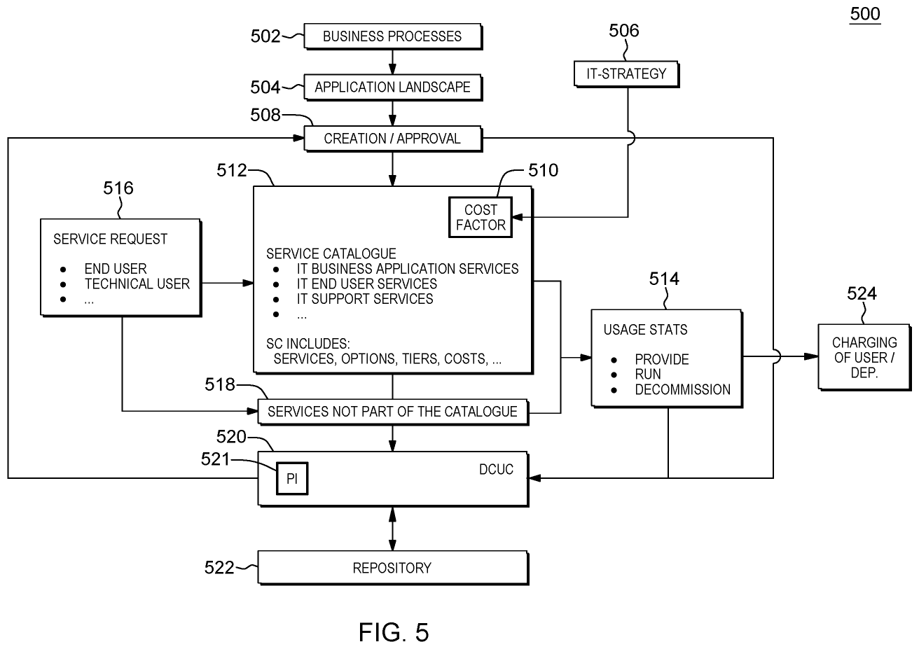

As shown in FIG. 5, context diagram 500 illustrates the overall service catalog lifecycle. Context diagram 500 includes: business processes block 502; application landscape block 504; IT strategy block 506; creation/approval block 508 (controlled by the catalog owner, not separately shown in FIG. 5); cost factor block 510; service catalog 512; usage stats block 514; service request block 516; services not part of the catalog block 518; DCUC 520 (sometimes herein referred to as first client DCUC 520); PI 521; repository 522 (sometimes herein referred to as first client repository 522); and charging of user/department block 524. The main components of context diagram 500 are DCUC 520 and PI 521. Repository 522 stores information regarding: (i) provided services; and (ii) usage statistics (such as services, options, tiers, duration).

Service catalog 512 itself can already exist or can be created from scratch with the introduction of DCUC 520 in the process workflow. The DCUC is customizable to support any catalog structure. In some embodiments, it should be built with a strong service orientation, with varying degrees of granularity. However, this is not a prerequisite and the DCUC can be used for any type of catalog, be it along services, along towers, technology or any other format that fits the user base.

Application landscape block 504 sends the following information to creation/approval block 508: important information; relevance information; frequency of usage information; and the like. Creation/approval block 508 is optional and sends any necessary approvals to service catalog 512. Creation/approval block 508 also sends any decisions of approval/disapproval to DCUC 520. DCUC 520 sends recommendations to add/update/remove services to creation/approval block 508. Service catalog 512 includes current catalog data. Usage statistics block 514 sends costs and bills to charging of user/department block 524.

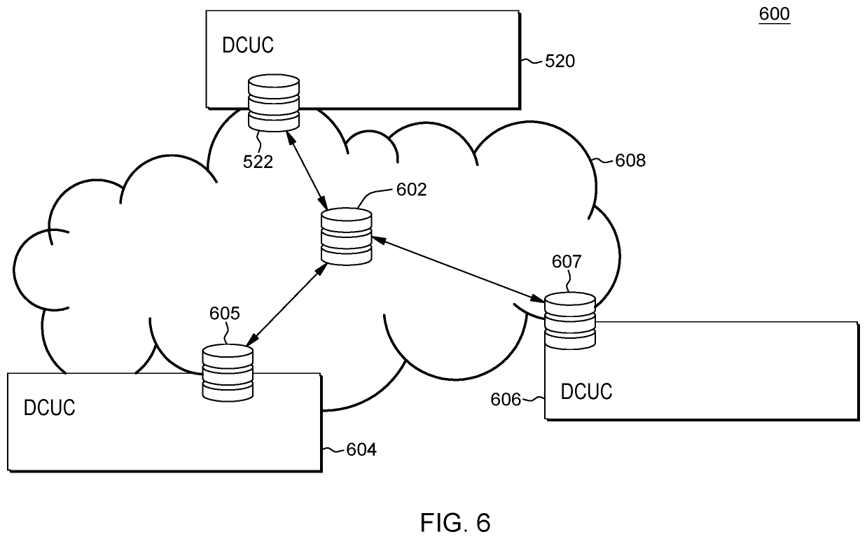

As shown in FIG. 6, cross-client knowledge base system 600 includes: first client DCUC 520; first client repository 522; cross-client knowledge base 602 (with non-confidential information across clients); second client DCUC 604; second client repository 605; third client DCUC 606; third client repository 607; and communication network 608. In system 600, non-confidential information from catalogs of various clients is extracted and shared for the re-use and optimization of other DCUCs and catalogs. This can be achieved by placing a repository instance on a private segment in a private cloud and selectively feeding that into a “data lake” with anonymous data from all managed catalogs. This can add additional learning capabilities and can increase the overall efficiency of some embodiments of the present invention, as a client that is about to start can immediately benefit from a potentially vast set of common practices and recommendations. Every time there is a change in the catalog or a service is requested, provided or terminated by the user the DCUC will capture the information and store it in its repository.

Recommendations of the DCUC to update the service catalog will be approved by the owner of the service catalog. Small changes to existing service (for example a new tier for the size of storage or of a mailbox) could automatically be applied to the corresponding service and entry in the service catalog, that is without human approval. Of course, these adaptions will be documented accordingly, for example through the creation of a corresponding change record. The decision of the approver to approve or reject service catalog changes is communicated back to the DCUC to optimize the DCUC/PI (for example, based on the adaptation of the corresponding thresholds).

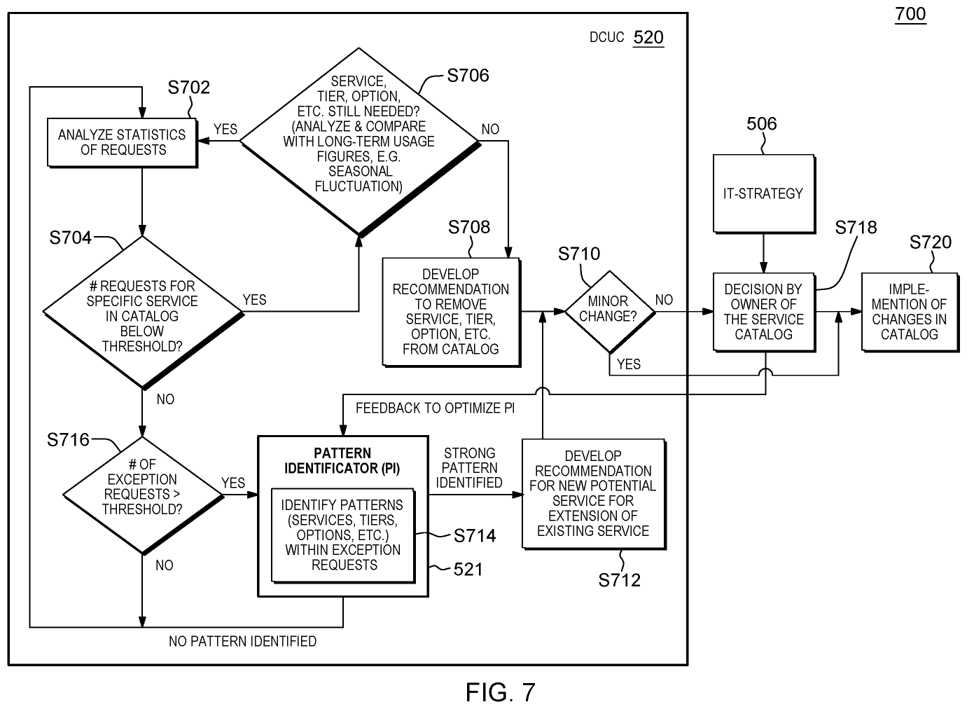

DCUC 520 monitors and analyzes the usage statistics of all service requests, that is of requests for services which are part of the catalog as well as requests for services on an exceptional basis. Flowchart 700 of FIG. 7 shows a method for performing this monitoring and analysis. The operations of flowchart 700 are as follows (with process flow among and between the operations shown by arrows in FIG. 7): S702; S704; S706; S708; S710; S712; S714; S716; S718; and S720. As further shown in FIG. 7, IT strategy block 506 performs operation S718. As further shown in FIG. 7, PI 521 performs operation S714. The method of flowchart 700 will now be further explained in the following two paragraphs.

If the usage of specific services of the service catalog is below a certain threshold, it is tested whether there are specific reasons (for example, only seasonal usage). This test can be based on historical data provided by the repository of the DCUC. Based on this analysis, a recommendation to remove this specific service from the catalog could be developed.

If the number of exception requests is above a certain threshold, PI 521 is triggered to analyze whether there is a specific pattern within these exception requests. The result of this analysis can be used to potentially recommend a new service. If exception requests are similar to existing services, the analysis can be used to recommend the extension of an existing service.

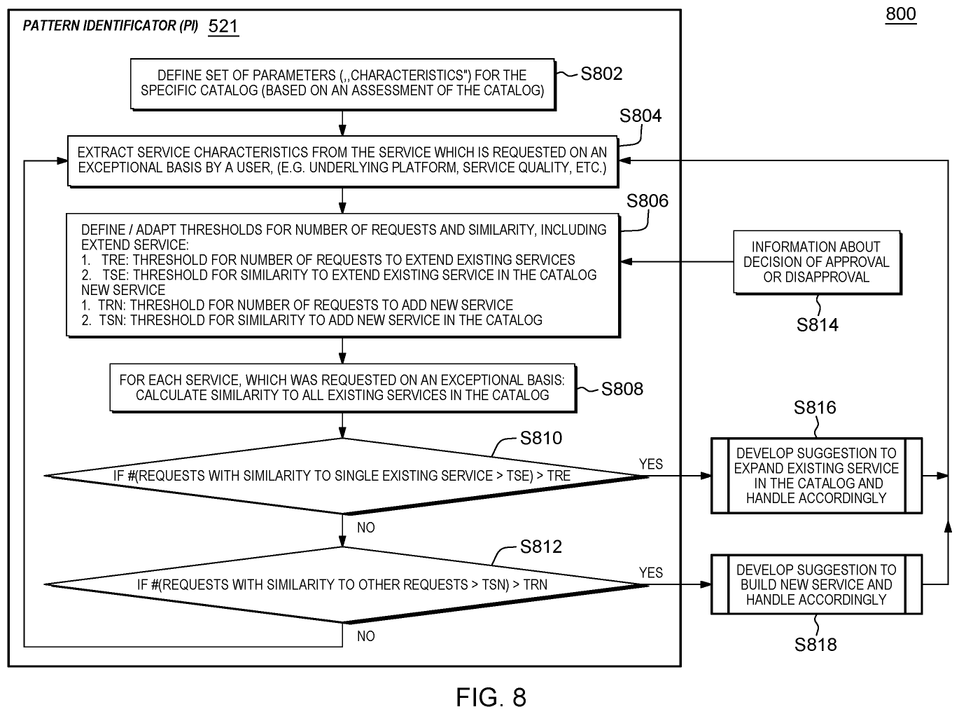

Shown in FIG. 8, flowchart 800 shows a method for the dynamic augmentation of a service catalog. The operations of flowchart 800 are as follows (with process flow among and between the operations shown by arrows in FIG. 7): S802; S804; S806; S808; S810; S812; S814; S816; and S818.

In operation S802, the relevant characteristics of a specific class of service is defined. For infrastructure services this may include the underlying platform (hardware and software), storage, network, SLAs, etc. In operation S804, for each service request on exception basis the specific values according to these characteristics are extracted. Operation S808, the characteristics of this service request are compared with the characteristics of the existing services within the catalog. If there is a high number of new requests similar to an existing service in the catalog, the PI triggers the expansion of this existing service (see operations S810 and S816). If there is a high number of similar requests, which are not similar to an existing service in the service catalog, the PI triggers the development of a new service (see operations S812 and S818). The actual decision to adapt the catalog will typically be done by a human. Small changes to existing service (for example, a new tier for the size of storage or of a mailbox) could automatically be applied to the corresponding service and entry in the service catalog, that is without human approval. The decision of the approver to approve or reject a specific request flows back to the PI to adapt the corresponding thresholds.

Some embodiments of the present invention may include one, or more, of the following features, characteristics, components, operations and/or advantages: (i) uses not only user-based input, but also consumption data to build a data lake from where the catalog updates are generated automatically using analytics and cognitive technologies; (ii) uses AI based mechanisms to enhance a service catalog; and/or (iii) relies on data collection and analytics to derive service catalog optimization.

It's common to have deviations between established business objectives and the Enterprise IT service catalog. This is often caused by the gaps between business and IT. One reason is the lack of a structured process to derive the IT service catalog from the business objectives. But the main reason is, that there is no structured and dynamic process to keep it updated and consistent.

The service catalog represents a strategic element to implement the IT strategy. It allows the IT organization to channel the user requests into pre-configured services which are aligned to the overall IT strategy.

If the catalog does not reflect the requirements of the business, there is potentially a severe impact on business and on IT side. For example, business may not be able to perform efficiently because the necessary IT services are not provided as needed or not in the required timeframe. On IT side the number of exception requests increase. The handling of exception requests requires additional effort compared to the handling of services which are part of the catalog. On top of that we see significant additional effort to fulfill the request, build the service and to provide the service on an ongoing basis. In most cases exception requests cannot be channeled into standard services which are part of the catalog. Therefore, the resulting benefits for the IT organization cannot be leveraged (for example increase standardization and efficiency within IT).

As will be understood by those of skill in the art, there are various approaches to calculate the similarity between service/service requests, for example based on the Euclidean distance or any other distance vector algorithms.

Some embodiments of the present invention may include one, or more, of the following features, characteristics, components, operations and/or advantages: (i) the deployments and configurations are large and/or dynamic; (ii) allows the service catalog to expand to fit the needs of individual departments and requirements; (iii) allows for more standards or varying installation patterns, thereby making the service catalog more useful; (iv) not a top-down approach where existing set applications or portfolios are consolidated (manually or automatically), but, rather, a bottom-up approach, where the portfolio is actually defined through the actual usage of these applications/portfolios by the users; (v) utilizes consumption data to ensure that patterns are being used via a data lake; and/or (v) is highly dynamic, that, is if the usage of specific services changes over time, the system develops corresponding recommendations (or even autonomously implements them), to ensure that the portfolio meets the needs of the users.

Some embodiments of the present invention may include one, or more, of the following features, characteristics, components, operations and/or advantages: (i) utilizes the pre-existing architecture as a starting point for architecture enhancement; (ii) includes a dynamic update component for Service Catalogs, with an additional artifacts (Pattern Identifier—PI) that looks for common characteristics and is a fully integrated piece of the overall dynamic update process; (iii) analyzes and builds the catalog and without focusing on product configuration; and (iv) focus is on providing value by using business requests to automatically maintain the catalog of services, adding also a learning component and a function to provide human readable suggestions in case the update does not meet all the criteria for full automation.

Some embodiments of the present invention may include one, or more, of the following features, characteristics, components, operations and/or advantages: (i) use cognitive service based on common AI based techniques, such as advanced analytics and machine learning; and/or (ii) a Dynamic Catalog Update Component and the Pattern Identifier make use of AI based cognitive services to manage large amounts of data and provide insights in real time and use that information to build/enhance the service catalog.

The “dynamic” aspect of some embodiments of the present invention are not related to the frequency or timing of updates to the service catalog, but, rather to the fact that it is performed based on machine learning and without human intervention in most cases. In some embodiments, the update is routed through an approval mechanism requiring a human to make a decision (go/no go) for the automated process to continue. In some embodiments, this is only for major updates, like the creation of a completely new service based on (for example) a high number of similar request for exceptions from users. In some embodiments, most of the updates to the catalog should be automated.

Use of AI based techniques in connection with some embodiments of the present invention will now be discussed. Consistent with the definition of AI set forth, above, in the Background section of this document, some embodiments of the present invention interpret events, including service requests, service usage and/or a human decision to approve or disapprove a request. Based on these events the DCUC/PI supports the decision of the catalog owner through a corresponding recommendation. Alternatively, the DCUC/PI does an automated, autonomous decision. Finally, the DCUC/PI takes action and implements the decision in the service catalog. Starting with an initial catalog (for example based on the service catalogues of other enterprises), the underlying mathematical model is self-learning, where the patterns and catalog are continuously updated based on the above mentioned events.

Use of “advanced analytics” in connection with some embodiments of the present invention will now be discussed. Some embodiments of the present invention use advanced analytics because they autonomously extracts event (including service requests, service usage, human decisions), examines and analyzes the underlying data and generates a corresponding recommendation. The DCUC/PI covers a wide range of advanced analytics techniques including (but not limited to) data mining, machine learning, pattern matching and multivariate statistics.

Use of “machine learning” in connection with some embodiments of the present invention will now be discussed. Some embodiments of the present invention use machine learning because they perform self-learning based on the above mentioned events (including service requests, service usage, human decisions). Starting with an initial catalog, the underlying, mathematical system/algorithm (including patterns and service catalog) is continuously adapted based on the evaluation of the above events. The system/algorithm is permanently trained by service requests, service usage and human decisions. In some embodiments, the result is an optimized model of the required service catalogue with optimized corresponding recommendations.

For purposes of this document, “cognitive processing” is any form of computing that makes a new class of problems computable. It addresses complex situations that are characterized by ambiguity and uncertainty; in other words, it handles human kinds of problems. Data from various information sources are synthesized, while weighing context and conflicting evidence to suggest the best possible answers. To achieve this, cognitive systems include self-learning technologies that use data mining, pattern recognition and natural language processing to mimic the way the human brain works. Cognitive computing systems make context computable. They identify and extract context features such as hour, location, task, history or profile to present an information set that is appropriate for an individual or for a dependent application engaged in a specific process at a specific time and place.

Use of “cognitive processing” in connection with some embodiments of the present invention will now be discussed. Some embodiments of the present invention use cognitive processing because they automatically adapt to user requests for new or existing services over time. Some embodiments are interactive. Some embodiments interact with various stakeholders and systems including the interaction with users, analyzing their requests. Some embodiments interact with the owner of service catalog giving recommendations and observing their approval or disapproval. Some embodiments interact with the PIs of other organizations. Some embodiments are iterative—for example, at the beginning of the learning process until a solid database for the “home organization” is built. Based on this database it is stateful in developing new recommendations and in updating the existing database. The feedback of the catalog owner is used to update the DCUC (Dynamic Catalog Update Component). The DCUC is contextual especially when using various information sources during the analysis of requests. The DCUC does not only consider the actual data but also the corresponding context.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving an initial version of a service catalog including information indicative of: (i) a plurality of information technology services, (ii) a plurality of pattern definitions used to match user requests to information technology services of the plurality of technology information services;
receiving a consumption data set including information indicative of use of the plurality of information technology services and the initial version of the service catalog by a plurality of users;
applying artificial intelligence to modify an initial version of a first pattern definition of the plurality of pattern definitions based, at least in part, on the consumption data set to obtain a modified version of the first pattern definition; and
replacing the initial version of the first pattern definition with the modified version of the first pattern definition in the service catalog to obtain a modified version of the service catalog.

2. The CIM of claim 1 further comprising:
receiving a first user request for an information technology service, with the first user request including a plurality of parameter values related to the requested service;
determining that the plurality of parameter values of the first user request match the modified version of the first pattern definition in the modified version of the service catalog; and
responsive to the determination that the plurality of parameter values of the first user request match the modified version of the first pattern definition in the modified version of the service catalog, providing the first user with a first information technology service corresponding to the first pattern definition.

3. The CIM of claim 1 further comprising:
aligning the modified version of the service catalog with information technology strategy.

4. The CIM of claim 1 wherein the application of artificial intelligence includes machine learning.

5. The CIM of claim 1 wherein the application of artificial intelligence includes cognitive processing.

6. The CIM of claim 1 wherein the application of artificial intelligence includes advanced analytics.

7. A computer-implemented method (CIM) comprising:
receiving an initial version of a service catalog including information indicative of: (i) a plurality of information technology services, (ii) a plurality of pattern definitions used to match user requests to information technology services of the plurality of technology information services;
receiving a consumption data set including information indicative of use of the plurality of information technology services and the initial version of the service catalog by a plurality of users;
applying artificial intelligence to recommend a new pattern definition and corresponding new information technology service based, at least in part, on the consumption data set;
obtaining approval to add the new pattern definition and corresponding new information technology service to the service catalog; and
responsive to the approval to add the new pattern definition and corresponding new information technology service to the service catalog, adding the new pattern definition and corresponding new information technology service to the initial version of the service catalog to obtain a modified version of the service catalog.

8. The CIM of claim 7 further comprising:
receiving a first user request for an information technology service, with the first user request including a plurality of parameter values related to the requested service;
determining that the plurality of parameter values of the first user request match the new pattern definition in the modified version of the service catalog; and
responsive to the determination that the plurality of parameter values of the first user request match the new version of the first pattern definition in the modified version of the service catalog, providing the first user with the new information technology service corresponding to the new pattern definition.

9. The CIM of claim 7 further comprising:
aligning the modified version of the service catalog with information technology strategy.

10. The CIM of claim 7 wherein the application of artificial intelligence includes machine learning.

11. The CIM of claim 7 wherein the application of artificial intelligence includes cognitive processing.

12. The CIM of claim 7 wherein the application of artificial intelligence includes advanced analytics.

13. A computer-implemented method (CIM) comprising:
receiving a first version of a service catalog including information indicative of: (i) a plurality of information technology services, (ii) a plurality of pattern definitions used to match user requests to information technology services of the plurality of technology information services, with each pattern definition including a plurality of parameter value ranges respectively corresponding to a plurality of relevant parameters;
receiving a consumption data set including information indicative of use of the plurality of information technology services and the first version of the service catalog by a plurality of users;
automatically modifying a first version of a first pattern definition of the plurality of pattern definitions based, at least in part, on the consumption data set to obtain a second version of the first pattern definition, with the modification of the first pattern definition including a change to a first parameter value range included in the first pattern definition; and
replacing the first version of the first pattern definition with the second version of the first pattern definition in the service catalog to obtain a second version of the service catalog.

14. The CIM of claim 13 further comprising:
receiving a first user request for an information technology service, with the first user request including a plurality of parameter values related to the requested service;
determining that the plurality of parameter values of the first user request match the second version of the first pattern definition in the second version of the service catalog; and
responsive to the determination that the plurality of parameter values of the first user request match the second version of the first pattern definition in the second version of the service catalog, providing the first user with a first information technology service corresponding to the first pattern definition.

15. The CIM of claim 13 wherein the plurality of relevant parameters include at least one of the following parameter types: operating system, VM size, management characteristics, environment type, application type, backup configuration, geo-location related, staffing related, storage I/O requirements, virtual network interface controller capabilities, ratio between memory capacity and processing power, cloud provider related, network attachment configuration related, basic security configuration, and/or cluster type related.

16. The CIM of claim 13 wherein the plurality of relevant parameters include all of the following parameter types: operating system, VM size, management characteristics, environment type and application type.

17. The CIM of claim 13 wherein the change to the first parameter value range makes the first parameter value range more inclusive.

18. The CIM of claim 13 wherein the change to the first parameter value range makes the first parameter value range less inclusive.
